(19) United States
(12) Patent Application Publication
(10) Pub. No.: US 2013/0053459 A1
(43) Pub. Date: Feb. 28, 2013

(54) IONIC POLYMER AND PROCESS FOR ITS PRODUCTION

(71) Applicants: Junichi Tayanagi, Chiyoda-ku (JP); Takeshi Hirai, Chiyoda-ku (JP)

(72) Inventors: Junichi Tayanagi, Chiyoda-ku (JP); Takeshi Hirai, Chiyoda-ku (JP)

(73) Assignee: Asahi Glass Company, Limited, Chiyoda-ku (JP)

(21) Appl. No.: 13/563,978

(22) Filed: Aug. 1, 2012

(30) Foreign Application Priority Data
Aug. 31, 2011 (JP) 2011-188305

(51) Int. Cl. C08F 14/26

(52) U.S. Cl. 521/32

(57) ABSTRACT

To obtain an ionic polymer having a high ion exchange capacity and a low moisture content, by simply converting a —SO₂F group in a polymer to a pendant group having a plurality of ion exchange groups, while preventing a cross-linking reaction. A process for producing an ionic polymer, which comprises (A) a step of converting a —SO₂F group in a polymer to a —SO₂NZ¹Z² group (each of Z¹ and Z² which are independent of each other, is a group selected from a hydrogen atom, a monovalent metal element and a trimethylsilyl group), (B) a step of reacting the polymer obtained in the step (A) with FSO₂(CF₂)₂SO₂F, and (C) a step of converting a terminal —SO₂F group of a side chain in the polymer obtained in the step (B) to an ion exchange group such as a —SO₃H group; and an ionic polymer obtained by such a process.

### BACKGROUND OF THE INVENTION

1. Field of the Invention

The present invention relates to an ionic polymer and a process for its production.

2. Discussion of Background

As an electrolyte material contained in e.g. ion exchange membranes or electrolyte membranes for polymer electrolyte fuel cells, an ionic polymer has been known which has a plurality of ion exchange groups such as sulfonic acid groups (—SO₃H groups) or sulfonimide groups (—SO₂N(H)— groups) in one pendant group. Such an ionic polymer has a less degree of swelling by water even if the ion exchange capacity is made high and thus has a good dimensional stability, as compared with an ionic polymer having one ion exchange group in one pendant group.

The following processes (1) to (4) may, for example, be mentioned as processes for producing an ionic polymer having a plurality of ion exchange groups in one pendant group.

Process (1): A process which comprises preparing a monomer having a plurality of ion exchange groups in one pendant group, and polymerizing such a monomer with e.g. tetrafluoroethylene (TFE) (e.g. Non-Patent Document 1).

Process (2): A process which comprises the following steps (X1) to (X3)

### (Patent Document 1):

(X1): a step of converting —SO₂F groups in a polymer having the —SO₂F groups to —SO₂NH₂ groups,

(X2): a step of reacting the polymer having the —SO₂NH₂ groups with FSO₂(CF₂)₃SO₂F to convert some of the —SO₂NH₂ groups to —SO₂NHSO₂(CF₂)₃SO₂F groups, while cross-linking the —SO₂NH₂ groups to one another, and

(X3): a step of converting the —SO₂NHSO₂(CF₂)₃SO₂F groups to —SO₂NHSO₂(CF₂)₃SO₃H groups.

Process (3): A process which comprises the following steps (Y1) to (Y3)

### (Patent Document 1):

(Y1): a step of converting —SO₂F groups in a polymer having the —SO₂F groups to —SO₂NH₂ groups,

(Y2): a step of reacting the polymer having the —SO₂NH₂ groups with FSO₂(CF₂)₃I to convert the —SO₂NH₂ groups to —SO₂NHSO₂(CF₂)₃I groups, and

(Y3): a step of converting the —SO₂NHSO₂(CF₂)₃I groups to —SO₂NHSO₂(CF₂)₃SO₃H groups.

Process (4): A process which comprises the following steps (Z1) and (Z2) (Non-Patent Document 2):

(Z1): a step of reacting a polymer having —SO₂NH₂ groups with an excess amount of a compound having at least two FSO₂ groups exemplified by FSO₂(CF₂)ₙSO₂F, to convert the —SO₂NH₂ groups to —SO₂NHSO₂(CF₂)ₙSO₂F groups, and

(Z2): a step of converting the —SO₂NHSO₂(CF₂)ₙSO₂F groups to —SO₂NHSO₂(CF₂)ₙ SO₃H groups.
Patent Document 1: JP-A-2002-324559
Non-Patent Document 1: Proceedings Electrochem. Soc., 94, -23 (1994), p265
Non-Patent Document 2: U.S. Department of Energy Hydrogen Program 2010 Annual Merit Review & Peer Evaluation, lecture No. FC034

### SUMMARY OF THE INVENTION

However, the process (1) has such a problem that the monomer having such a pendant group has a high boiling point, whereby it is difficult to purify the monomer by distillation. Further, such a monomer is water-soluble and is hardly soluble in a fluorinated solvent, whereby solution polymerization in a fluorinated solvent is difficult, and the polymerization method is limited. Further, if it is attempted to stabilize unstable terminals of the obtained polymer with fluorine gas, ion exchange groups are likely to react with fluorine, whereby it is difficult to maintain ion exchange groups, and it is difficult to obtain sufficient durability.

The polymer obtainable by the process (2) has cross-links substantially, and thus is poor in solubility in a solvent. Accordingly, it is difficult to prepare a solution of the polymer, and it is difficult to make an electrolyte membrane to be thin by using a coating method such as a casting method.

The polymers obtainable by the processes (3) and (4) have no cross-links. However, FSO₂(CF₂)₃I to be used in the process (3) is difficult to synthesize. Further, in the step (Y3), it is necessary to convert the terminals to —SO₃H groups, but such a reaction is cumbersome and is likely to produce an iodine compound having a large molecular weight in a large amount as a by-product and thus can hardly be regarded as a practical useful reaction. In the process (4), SO₂F groups at both sides of FSO₂(CF₂)ₙSO₂F are likely to react, and therefore, in order to prevent cross-linking to —SO₂NH₂ groups in the polymer, it is usually necessary to add FSO₂(CF₂)ₙSO₂F in an excess amount. In Non-Patent Document 2, it is disclosed that by using FSO₂(CF₂)₃SO₂F, cross-linking is substantially prevented. However, the degree of the excess amount for the reaction is not disclosed. In Example 1 in Patent Document 1, cross-linking by the same compound is carried out, and this indicates that in order to carry out the reaction while suppressing the cross-linking, it is necessary to add the compound in excess, such being not economical.

Further, FSO₂(CF₂)₃SO₂F to be used in the processes (2) and (4) is prepared, for example, by converting the terminals of I(CF₂)₃I to SO₂F groups. I(CF₂)₃I is prepared by a method of adding TFE to ICF₂I (J. Org. Chem. 69(7)2394 (2004), etc.), but in such a method, I(CF₂)₂I, I(CF₂)₄I, etc. will be formed as by-products, and purification is difficult. Especially, if FSO₂(CF₂)₄SO₂F is contained as an impurity, as mentioned hereinafter, such FSO₂(CF₂)₄SO₂F is likely to cause gellation, since the reactivity of the functional groups at both ends is equal, and further, there is such a problem that the water uptake of the polymer becomes excessively high.

Further, FSO₂(CF₂)₃SO₂F can be prepared also by a method of subjecting FSO₂(CH₂)₃SO₂F to electrolytic fluorination. However, preparation of FSO₂(CH₂)₃SO₂F requires many steps, and the yield is not high enough, such being hardly regarded as practical. Further, the yield in the electrolytic fluorination is also low, and impurities not sufficiently fluorinated will remain, whereby purification is very difficult. Accordingly, if the obtained material is, for example, used as an electrolyte material for a fuel cell, no adequate durability may be obtainable.

It is an object of the present invention to provide a process for producing an ionic polymer, whereby a —SO₂F group in a polymer can be converted to a pendant group having a plurality of ion exchange groups by a simple method, while preventing a cross-linking reaction, and it is possible to obtain an ionic polymer having a high ion exchange capacity and a low water uptake, and an ionic polymer obtainable by such a process.

The process for producing an ionic polymer of the present invention is a process which comprises the following steps (A) to (C):

(A) a step of converting a group represented by the following formula (1), in a polymer having repeating units having the group represented by the formula (1), to a group represented by the following formula (2),

(B) a step of reacting the polymer obtained in the step (A) with a compound represented by the following formula (3) to convert the group represented by the formula (2) in the polymer to a group represented by the following formula (4), and

(C) a step of converting the group represented by the formula (4) in the polymer obtained in the step (B) to a group represented by the following formula (5),

—SO₂F (1)

—SO₂NZ¹Z² (2)

FSO₂(CF₂)₂SO₂F (3)

—SO₂N⁻(M⁺)SO₂(CF₂)₂SO₂F (4)

—SO₂N⁻(M⁺)SO₂(CF₂)₂SO₂X⁻(M⁺)(SO₂R^{f})ₘ (5)

wherein each of Z¹ and Z² which are independent of each other, is a group selected from the group consisting of a hydrogen atom, a monovalent metal element and −Si(R)₃, R is a hydrogen atom or a C₁₋₁₂ monovalent organic group which may have an etheric oxygen atom, three R may be the same groups or different groups, M⁺ is a hydrogen ion, a monovalent metal cation or a monovalent cation derived from an organic amine, X is an oxygen atom or a nitrogen atom, m is 0 when X is an oxygen atom, or 1 when X is a nitrogen atom, and R^{f} is a C₁₋₁₀ perfluoroalkyl group which may have at least one etheric oxygen atom.

In the step (B), the molar ratio of the compound represented by the formula (3) to the group represented by the formula (2) is preferably from 0.5 to 20.

Further, the polymer having the group represented by the formula (1) is preferably a perfluoropolymer, wherein hydrogen atoms bonded to carbon atoms in the main chain and side chains are all substituted by fluorine atoms.

Further, the ionic polymer of the present invention is an ionic polymer having repeating units having a group represented by the above formula (5).

According to the process for producing an ionic polymer of the present invention, it is possible to convert a —SO₂F group in a polymer to a pendant group having a plurality of ion exchange groups by a simple method, while preventing a cross-linking reaction, and it is possible to obtain an ionic polymer having a high ion exchange capacity and a low water uptake.

Further, the ionic polymer of the present invention is capable of satisfying both a high ion exchange capacity and a low water uptake.

### BRIEF DESCRIPTION OF THE DRAWINGS

FIG. 1 is a graph showing the results obtained by measuring the conductivities of films made of ionic polymers in Examples 2, 6, 7 and 8 given hereinafter.

FIG. 2 is a graph showing the results obtained by measuring the conductivities of films made of ionic polymers in Examples 9 and 10 given hereinafter.

### PREFERRED EMBODIMENTS OF THE INVENTION

In this specification, a group represented by the formula (1) may be referred to as a group (1), and other groups may likewise be referred to in the same manner.

Likewise, a compound represented by the formula (3) may be referred to as a compound (3).

The process for producing an ionic polymer of the present invention comprises the following steps (A) to (C):

(A) a step of converting the following group (1), in a polymer having repeating units having the group (1) (hereinafter referred to as “the polymer (i)”), to the following group (2),

(B) a step of reacting the polymer obtained in the step (A) with the following compound (3) to convert the group (2) in the polymer (i) to the following group (4), and

(C) a step of converting the group (4) in the polymer obtained in the step (B) to the following group (5),

—SO₂F (1)

—SO₂NZ¹Z² (2)

FSO₂(CF₂)₂SO₂F (3)

—SO₂N⁻(M⁺)SO₂(CF₂)₂SO₂F (4)

—SO₂N⁻(M⁺)SO₂(CF₂)₂SO₂X⁻(M⁺)(SO₂R^{f})ₘ (5)

wherein each of Z¹ and Z² which are independent of each other, is a group selected from the group consisting of a hydrogen atom, a monovalent metal element and —Si(R)₃, R is a hydrogen atom or a C₁₋₁₂ monovalent organic group which may have an etheric oxygen atom, three R may be the same groups or different groups, M⁺ is a hydrogen ion, a monovalent metal cation or a monovalent cation derived from an organic amine, X is an oxygen atom or a nitrogen atom, m is 0 when X is an oxygen atom, or 1 when X is a nitrogen atom, and R^{f} is a C₁₋₁₀ perfluoroalkyl group which may have at least one etheric oxygen atom.

Step (A):

The group (1) in a side chain in the polymer (i) is converted to the group (2) to obtain a polymer having the group (2) (hereinafter referred to as “the polymer (ii)”).

The monovalent metal element for Z¹ and Z² may, for example, be an alkali metal. Among them, sodium and/or potassium is preferred from the viewpoint of availability and economical efficiency, and lithium is preferred in a case where swelling or solubility in a solvent is required.

As —Si(R)₃ for Z¹ and Z², —Si(CH₃)₃ may, for example, be mentioned.

As the method for converting the group (1) to group (2), the following methods (α) and (β) may be mentioned depending upon the type of the group (2).

Method (α): In a case where Z¹ and Z² in the group (2) are hydrogen atoms, i.e. the group (2) is a —SO₂NH₂ group.

Method (β): In a case where at least one of Z¹ and Z² in the group (2) is a group selected from the group consisting of a monovalent metal element and —Si(R)₃.

Now, the methods (α) and (β) will, respectively, be described in detail.

(Method (α))

Ammonia is contacted to the polymer (i) to convert the group (1) in a side chain to a —SO₂NH₂ group. The method to contact ammonia to the polymer (i) may, for example, be a method of directly contacting ammonia to the polymer (i), a method of blowing ammonia into a polymer solution having the polymer (i) dissolved therein, for bubbling, or a method of contacting the polymer (i) in a state swelled in a solvent, with ammonia.

The temperature at the time of contacting ammonia is preferably from −80° C. to 50° C., more preferably from −30° C. to 30° C.

(Method (β))

The method (β) may, for example, be the following method (β1) or (β2).

Method (β1): NHZ¹¹Z²¹ (wherein each of Z¹¹ and Z²¹ which are independent of each other, is a group selected from the group consisting of a hydrogen atom, a monovalent metal element and —Si(R)₃, and at least one of them is a monovalent metal element or —Si(R)₃) is contacted to the polymer (i) having the group (1) to convert the group (1) to a —SO₂NZ¹¹Z²¹ group.

Method (β2): Ammonia is contacted to the polymer (i) having the group (1) to convert the group (1) to a —SO₂NH₂ group, followed by a method of further reacting an oxide, hydroxide, carbonate, hydride, etc. of a monovalent metal element or a method of further reacting (R)₃SiNHSi(R)₃, to convert the —SO₂NH₂ group to a —SO₂NZ¹¹Z²¹ group. However, the method of converting the —SO₂NH₂ group to the —SO₂NZ¹¹Z²¹ group is not limited to the above methods.

In the method (β1), the method of contacting NHZ¹¹Z²¹ to the polymer (i) may, for example, be a method of directly contacting NHZ¹¹Z²¹ to the polymer (i), a method of contacting NHZ¹¹Z²¹ to a polymer solution having the polymer (i) dissolved therein, or a method of contacting the polymer (i) in a state swelled in a solvent, with NHZ¹¹Z²¹.

In the method (β2), the method of contacting ammonia to the polymer (i) may be the same method as the method mentioned for the method (α).

In the step (A), it is preferred to convert the group (1) to a —SO₂NH₂ group from the viewpoint of the reactivity with the polymer (i). As such a method, a method of contacting ammonia is preferred from the viewpoint of the reactivity.

Further, with respect to the polymer (i) to be used in the step (A), it is preferred that unstable groups at terminals of the polymer are preliminarily fluorinated and converted to stable groups, by using e.g. fluorine gas. It is thereby possible to improve the durability of the obtainable ionic polymer.

The polymer (i) is not particularly limited so long as it is a polymer having the —SO₂F group. The polymer (i) may be a perfluoropolymer wherein hydrogen atoms bonded to carbon atoms in the main chain and side chains are all substituted by fluorine atoms, a fluoropolymer wherein some of hydrogen atoms bonded to carbon atoms in the main chain and side chains are substituted by fluorine atoms, or a polymer wherein hydrogen atoms bonded to carbon atoms in the main chain and side chains are not substituted by fluorine atoms. Further, it may be a polymer wherein among hydrogen atoms bonded to carbon atoms in the main chain and side chains, those not substituted by fluorine atoms are substituted by substituents other than fluorine atoms (such as chlorine atoms). Particularly in a case where the material of the present invention is used in an application such as a fuel cell wherein high durability against OH radicals is required, the polymer (i) is preferably a perfluoropolymer, wherein hydrogen atoms bonded to carbon atoms in the main chain and side chains are all substituted by fluorine atoms, especially from the viewpoint of chemical stability.

Further, the polymer (i) is preferably a polymer having repeating units having the following group (11) from such a viewpoint that a higher ion exchange capacity is thereby obtainable. By using such a polymer, it is possible to obtain a polymer (ii) having repeating units having the following group (21).

—(OCF₂CFR¹)ₐOCF₂(CFR²)_{b}SO₂F (11)

—(OCF₂CFR¹)ₐOCF₂(CFR²)_{b}SO₂NZ¹Z² (21)

wherein each of R¹ and R² which are independent of each other, is a fluorine atom, a chlorine atom or a C₁₋₁₀ perfluoroalkyl group which may have at least one etheric oxygen atom, a is 0, 1 or 2, b is an integer of from 0 to 6, and Z¹ and Z² are as defined above.

R′ is preferably a fluorine atom or a —CF₃ group.

R² is preferably a fluorine atom or a —CF₃ group.

a is preferably from 0 to 2.

b is preferably from 1 to 5.

Specific examples of the group (11) may, for example, be the following groups:

—O—(CF₂)₂SO₂F,

—OCF₂CF(CF₃)O(CF₂)₂SO₂F,

The polymer (i) having repeating units having the group (11) can be obtained by polymerizing a monomer having the group (11). The monomer having the group (11) may, for example, be the following monomers.

CF₂═CF—O—(CF₂)₂SO₂F,

CF₂═CF—OCF₂CF(CF₃)O(CF₂)₂SO₂F, etc.

Among them, a monomer having a short side chain is preferred in order to reduce the water uptake in a obtainable ionic polymer, and a monomer having little etheric oxygen atom in a side chain is preferred. From such viewpoints, CF₂═CF—O—(CF₂)₂SO₂F is preferred.

Further, as the polymer (i), a polymer having repeating units having —CF₂—O—(CF₂)₂SO₂F is also preferred, and rather than a monomer wherein an etheric oxygen atom is directly bonded to the main chain, one wherein a —CF₂— group having a high steric hindrance is directly bonded to the main chain is preferred in that a hard polymer (i) is readily obtainable, and CF₂═CF—CF₂—O—(CF₂)₂SO₂F is particularly preferred in that it can be prepared in good yield in a short process as disclosed in JP-A-58-96630, and the cost will be industrially low.

The polymer (i) may be a polymer obtained by polymerizing only the monomer having the group (11) or a polymer obtained by copolymerizing the monomer having the group (11) with another monomer. However, a polymer obtained by copolymerizing the monomer having the group (11) with another monomer is preferred, since the mechanical strength of the ionic polymer will be higher, the water uptake will be more reduced, a high dimensional stability is readily obtainable, and further it is easy to prevent the ion exchange capacity from becoming too high.

Another monomer may, for example, be a perfluoromonomer wherein hydrogen atoms bonded to carbon atoms are all substituted by fluorine atoms, a fluoromonomer wherein some of hydrogen atoms bonded to carbon atoms are substituted by fluorine atoms, or a monomer wherein hydrogen atoms bonded to carbon atoms are not substituted by fluorine atoms. Another monomer is particularly preferably a perfluoromonomer from the viewpoint of durability and chemical stability.

Another monomer may, for example, be tetrafluoroethylene (TFE), hexafluoropropylene (HFP), vinylidene fluoride, chlorotrifluoroethylene, trifluoroethylene, a vinyl ether (such as CF₂═CF—O—C₃F₇, CF₂═CF—O—CF₂—CF(CF₃)—O—C₃F₇, ethylene, propylene, 1-butene, isobutylene, methyl vinyl ether or ethyl vinyl ether), etc. Further, a cyclic monomer such as perfluoro(2,2-dimethyl-1,3-dioxol), perfluoro(1,3-dioxol), perfluoro(2-methyl-1,3-dioxol), perfluoro(2-ethyl-1,3-dioxol), perfluoro(2,2-diethyl-1,3-dioxol), perfluoro(2-methylene-4-methyl-1,3-dioxolane), perfluoro(2-methylene-4-ethyl-1,3-dioxolane), perfluoro(2-methylene-4-butyl-1,3-dioxolane) or 2,2,4-trifluoro-5-trifluoromethoxy-1,3-dioxol, or a cyclopolymerizable monomer such as perfluoro(3-butenyl vinyl ether), perfluoro[(1-methyl-3-butenyl)vinyl ether], perfluoro(allyl vinyl ether) or 1,1′-[(difluoromethylene)bis(oxy)]bis[1,2,2-trifluoroethene] may also be used.

Among them, from the viewpoint of e.g. the durability of an obtainable polymer, a perfluoromonomer is preferred, and from the viewpoint of the copolymerizability, it is particularly preferred to use TFE.

The proportion of repeating units having the group (11) in the polymer (i) is preferably from 2 to 50 mol %, more preferably from 5 to 30 mol %, particularly preferably from 10 to 25 mol %, based on all repeating units. When the proportion is at least the lower limit value, an ionic polymer having a high ion exchange capacity tends to be readily obtainable. If the proportion is at most the upper limit value, the mechanical strength of the ionic polymer tends to be higher, the water uptake tends to be more reduced, and a high dimensional stability tends to be readily obtainable.

Further, the content of the group (1) in the polymer (i) is preferably from 0.5 to 5 mmol/g, more preferably from 0.8 to 3 mmol/g, particularly preferably from 1.0 to 2.0 mmol/g. When the content of the group (1) is at least the lower limit value, an ionic polymer having a high ion exchange capacity tends to be readily obtainable. When the content of the group (1) is at most the upper limit value, the water uptake tends to be readily reduced, and a high dimensional stability tends to be readily obtainable.

As the polymerization method for the polymer (i), a known polymerization method can be employed.

Step (B):

The polymer (ii) is reacted with the compound (3) to obtain a polymer having the group (2) converted to the group (4) (hereinafter referred to as a “polymer (iii)”). In a case where the group (2) is the group (21), a polymer (iii) having repeating units having the following group (41) is obtainable.

—(OCF₂CFR¹)ₐOCF₂(CFR²)_{b}SO₂N⁻(M⁺)SO₂(CF₂)₂SO₂F (41)

wherein R¹, R², a, b, Z¹ and Z² are as defined above.

In a case where M⁺ in the group (4) is a monovalent metal cation, such a metal cation may, for example, be a sodium ion or a potassium ion. In a case where M⁺ in the group (4) is a monovalent cation derived from an organic amine, such a cation may, for example, be a tertiary amine such as trimethylamine, triethylamine, tripropylamine, tributylamine, N,N,N′,N′-tetramethylethylenediamine or 1,4-diazabicyclo[2.2.2]octane.

The compound (3) can be prepared by a known method. For example, there may be mentioned a method (b1) wherein |CF₂CF₂| being an adduct of tetrafluoroethylene and iodine is used as a starting material, this starting material is converted to NaSO₂CF₂CF₂SO₂Na by a known method, then converted to CISO₂CF₂CF₂SO₂Cl and finally converted to FSO₂CF₂CF₂SO₂F, or a method (b2) wherein TFE and sulfuric anhydride are reacted to obtain tetrafluoroethanesulfone, which is ring-opened and then hydrolyzed to obtain FSO₂CF₂COOH, which is further subjected to coupling by Kolbe electrolysis to obtain the compound (3) (e.g. WO2006/106960). Each of the above two methods is preferred in that a perfluorocompound is used, wherein as is different from a method for the synthesis by e.g. electrolytic fluorination, impurities containing C—H bond inferior in the durability as compared with C—F bonds will not be included. Between them, the method (b2) is more preferred since the number of steps is small, and the synthesis can be carried out industrially inexpensively.

The purity of the compound (3) is preferably at least 98%, more preferably at least 99%, further preferably at least 99.5%, as measured by gas chromatography. Further, in the measurement of the compound (3) by proton NMR, it is preferred that a peak of a C—H bond other than a C—H bond derived from the solvent contained in deuterated solvent is not detected.

In a case where the compound (3) is prepared by the method (b2), its purity is likely to be high. For example, if FSO₂(CF₂)₃SO₂F or the compound (3) is prepared by a method of electrolytically fluorinating its precursor FSO₂(CH₂)₃SO₂F or FSO₂(CH₂)₂SO₂F, impurities may be contained wherein not completely fluorinated C—H bonds remain (e.g. Journal of Fluorine Chemistry 35 (1987) P329). If a material containing such impurities is used as an electrolyte material for a fuel cell, the durability may not sufficiently be obtainable. It is difficult to purify such impurities, and it is also difficult to obtain a pure perfluorocompound by purification.

In the step (B), it is preferred that the polymer (ii) is swelled or dissolved in an aprotic polar solvent and then reacted with the compound (3).

The aprotic polar solvent is a solvent which does not easily donate protons. Such an aprotic polar solvent may, for example, be N,N-dimethylacetamide (DMAc), N,N-dimethylformamide (DMF), 1,3-dimethyl-2-imidazolidinone (DMI), N-methyl-2-pyrrolidone (NMP), dimethylsulfoxide, sulfolane, γ-butyrolactone, acetonitrile, tetrahydrofuran, 1,4-dioxane or CH₃O(CH₂CH₂O)_{c}CH₃ (wherein c is an integer of from 1 to 4). Among them, from the viewpoint of e.g. affinity to the polymer, DMAc, DMF, DMI, NMP or acetonitrile is preferred, and DMF, DMAc or acetonitrile is more preferred.

In the step (B), the mass ratio of the aprotic polar solvent to the polymer (ii) is preferably from 1:99 to 99:1, more preferably from 1:50 to 50:1, further preferably from 1:5 to 20:1, particularly preferably from 1:2 to 10:1. When the mass ratio of the polymer (ii) to the aprotic polar solvent is at least the lower limit value, it is possible to avoid use of the solvent more than necessary, and the reaction proceeds more efficiently. When the mass ratio of the polymer (ii) to the aprotic polar solvent is at most the upper limit value, it becomes easy to prevent a side reaction such as a cross-linking reaction and to let the reaction proceed uniformly, and a proper reaction rate tends to be easily obtainable.

The amount of the compound (3) to be used is preferably from 0.5 to 20, more preferably from 1 to 10, particularly preferably from 1.1 to 5, by molar ratio to the group (2) in the polymer (ii). When the above molar ratio is at least the lower limit value, a proper reaction rate is obtainable, and the conversion of the above group (2) to the group (4) can be easily adjusted to be sufficiently high, and an ionic polymer having a high ion exchange capacity tends to be easily obtainable. When the above molar ratio is at most the upper limit value, it is not necessary to use the compound (3) in an excess amount, such being advantageous from the viewpoint of the cost.

In the step (B), it is also preferred to use a reaction accelerator in the case of reacting the polymer (ii) with the compound (3). As such a reaction accelerator, a tertiary organic amine is preferred.

Such a tertiary organic amine may, for example, be a tertiary amine compound such as N,N′-tetramethylethylenediamine (TMEDA), trimethylamine, triethylamine, tripropylamine, tributylamine or 1,4-diazabicyclo[2.2.2]octane.

The amount of the reaction accelerator to be used is preferably from 1 to 20, more preferably from 2 to 5, by molar ratio to the group (2). When the amount of the reaction accelerator is at least the lower limit value, an ionic polymer having a high ion exchange capacity tends to be easily obtainable. When the amount of the reaction accelerator is at most the upper limit value, it is possible to efficiently remove and purify an excessive reagent.

In the step (B), it is preferred to use an aprotic polar solvent and reaction accelerator which have been subjected to dehydration treatment, with a view to preventing a side reaction such as hydrolysis of the compound (3). The dehydration treatment is not particularly limited and may, for example, be a method of using molecular sieves.

In the step (B), it is preferred not to let moisture be included to prevent hydrolysis of the compound (3), and it is preferred to react the polymer (ii) with the compound (3) in a nitrogen atmosphere.

In the step (B), the reaction temperature of the reaction of the polymer (ii) with the compound (3) is preferably from 0 to 150° C., more preferably from 20 to 80° C. When the reaction temperature is at least the lower limit value, the reaction efficiency will be improved. When the reaction temperature is at most the upper limit value, it is easy to prevent an undesirable side reaction such as a cross-linking reaction or decomposition reaction.

Further, by adjusting the group (2) of the polymer (ii) to be —SO₂NHM⁺ (wherein M⁺ is a monovalent metal such as Li⁺, Na⁺, K⁺ or Cs⁺), it is possible to obtain a polymer (iii) wherein M⁺ in the group (4) is a monovalent metal cation. Further, by a method of adjusting the group (2) to be —SO₂NH₂ and using the above-mentioned tertiary amine as the reaction accelerator, it is possible to obtain a polymer (iii) wherein M⁺ in the group (4) is a monovalent cation derived from an organic amine.

Step (C):

The group (4) in the polymer (iii) obtained in the step (B) is converted to the group (5) to obtain an ionic polymer. In a case where the group (4) is the group (41), an ionic polymer having repeating units having the following group (51) is obtainable.

—(OCF₂CFR¹)ₐOCF₂(CFR²)_{b}SO₂N⁻(M⁺)SO₂(CF₂)₂SO₂X⁻(M⁺)(SO₂R^{f})ₘ (51)

wherein R¹, R², a, b, m, Z¹, Z², X⁻, M⁺ and R^{f} are as defined above.

R^{f} in the group (5) is preferably a C₁₋₁₀ perfluoroalkyl group, more preferably a C₁₋₄ perfluoroalkyl group.

The group (51) may, for example, be the following groups.

—O—(CF₂)₂SO₂N⁻(M⁺)SO₂(CF₂)₂SO₂X⁻(M⁺)(SO₂R^{f})ₘ,

—OCF₂CF(CF₃)O(CF₂)₂SO₂N⁻(M⁺)SO₂(CF₂)₂SO₂X⁻(M⁺)(SO₂R^{f})ₘ, etc.

As the method for converting the group (4) to the group (5), the following methods (γ1) and (γ2) may be mentioned depending upon the type of the terminal in the group (5).

Method (γ1): a case where the terminal of the group (5) is a —SO₂—O⁻M⁺ group.

Method (γ2): a case where the terminal of the group (5) is a —SO₂—N⁻M⁺(SO₂R^{f}) group.

(Method (γ1))

The method for converting the terminal —SO₂F group in the group (4) in the polymer (iii) to a —SO₂—O⁻M⁺ group, may, for example, be a method for hydrolysis by using a basic solution of e.g. NaOH or KOH employing, as a solvent, water or a mixed liquid of water and an alcohol (such as methanol or ethanol) or a polar solvent (such as dimethylsulfoxide). The terminal —SO₂F group in the group (4) is thereby converted to a —SO₃Na group or a —SO₃K group. Further, thereafter, by treating with an aqueous solution of an acid such as hydrochloric acid, nitric acid or sulfuric acid, the —SO₃Na group, the —SO₃K group or the like may be formed into an acid form and converted to a —SO₃H group (sulfonic acid group).

The temperature for the hydrolysis and acid-form treatment is not particularly limited, but is preferably from 10 to 100° C., more preferably from 50 to 90° C.

(Method (γ2))

As the method for converting the terminal —SO₂F group in the group (4) in the polymer (iii) to a —SO₂—N⁻M⁺(SO₂R^{f}) group, a known method such as a method disclosed in U.S. Pat. No. 5,463,005 or Inorg. Chem. 32 (23) p. 5007 (1993) may be used. That is, the —SO₂F group in the polymer (iii) is reacted with a sulfonamide or the like and converted to a salt-form sulfonimide group derived from a base and thereafter further formed into an acid-form by means of an aqueous solution of e.g. hydrochloric acid or sulfuric acid and converted to an acid-form sulfonimide group. Further, the polymer (iii) may be contacted with ammonia to convert the —SO₂F group to a sulfonamide group, and then contacted with a compound having a —SO₂F group such as trifluoromethanesulfonyl fluoride, pentafluoroethanesulfonyl fluoride, nonafluorobutanesulsonyl fluoride or undecafluorocyclohexanesulfonyl fluoride in the presence of a basic compound such as an alkali metal fluoride or an organic amine, for conversion.

According to the process of the present invention as described above, the compound (3) is used in the step (B), whereby without using the compound (3) in a large excess, it is possible to produce an ionic polymer having the group (5) by a simple method, while preventing a cross-linking reaction from taking place. Therefore, it becomes easy to reduce the film thickness of an electrolyte film by using a coating method such as a casting method. That is, as is different from FSO₂(CF₂)₃SO₂F or FSO₂(CF₂)₄SO₂F, with the compound (3), if one —SO₂F group is reacted, the reactivity of the other —SO₂F group is reduced, whereby a cross-linking reaction tends to hardly proceed. Further, the pendant group (the group (5)) formed by the compound (3) has a lower water uptake than a pendant group formed by FSO₂(CF₂)₃SO₂F or FSO₂(CF₂)₄SO₂F. Therefore, the ionic polymer obtainable by the process of the present invention can satisfy both a high ion exchange capacity and a low water uptake.

Further, the compound (3) contains little impurities wherein the C—F bond in the compound (3) has been converted to a C—H bond during the synthesis, and therefore, it is easy to obtain one having a high purity. Accordingly, it is expected that an ionic polymer having excellent durability can be obtained. Further, before the steps (A) to (C), an unstable terminal of the polymer (i) can be preliminarily converted to a stable terminal of a perfluoro terminal by using e.g. fluorine gas, whereby it is expected that an ionic polymer having superior durability can be obtained.

In the ionic polymer obtainable by the process of the present invention, it is preferred that at least 50 mol % of the group (1) in the polymer (i) is converted to the group (5), it is more preferred that at least 80 mol % of the group (1) is converted to the group (5), and it is particularly preferred that 100 mol % of the group (1) is converted to the group (5), since a high ion exchange capacity thereby tends to be readily obtainable.

The ionic polymer obtainable by the process of the present invention is useful, for example, for a polymer electrolyte membrane for a fuel cell.

Such a polymer electrolyte membrane is obtained, for example, by filming the polymer (iii) obtained in the step (B) by a film-forming method such as forming a film by a casting method using a solution having the polymer (iii) dissolved in a solvent, melt-extruding the polymer (iii) or hot pressing the polymer (iii), and then carrying out the step (C). Otherwise, it may be obtained by carrying out the steps (A) to (C) after filming the polymer (i) by the above film-forming method. Or, the ionic polymer obtained by carrying out the steps (A) to (C) may be formed into a film by the above film-forming method.

Further, for such a polymer electrolyte membrane, the ionic polymer of the present invention may be reinforced by blending a polytetrafluoroethylene porous material, a polytetrafluoroethylene fiber (fibril) or the like thereto.

### EXAMPLES

Now, the present invention will be described in detail with reference to Examples, but it should be understood that the present invention is by no means restricted by the following description. Examples 1 to 3, 6 and 9 are Working Examples of the present invention, and Examples 4, 5, 7, 8 and 10 are Comparative Examples.

### Example 1

A polymer containing 1.1 mmol/g of a —SO₂F group, obtained by polymerizing TFE with a monomer represented by the following formula (m1), was contacted with fluorine gas and fluorinated to obtain a stabilized polymer (hereinafter referred to as “the polymer 1”).

CF₂═CF—OCF₂CF(CF₃)O(CF₂)₂SO₂F (m1)

Step (A):

10 g of the obtained polymer 1 was put into a pressure resistant container equipped with a stirrer together with 500 g of CF₃(CF₂)₅H and heated and stirred at 140° C. to prepare a solution. This solution was charged into a 1 L flask equipped with a stirrer and a dry ice condenser, and while cooling the flask with dry ice at room temperature of from 20 to 25° C., bubbling was continued for 10 hours not to let the internal temperature become −30° C. or lower by always refluxing ammonia, whereby the solution became turbid, and a white solid precipitated. Cooling by dry ice was stopped, and stirring was continued for 16 hours at room temperature of from 20 to 25° C., whereupon this solution was subjected to filtration, and the obtained solid was washed six times with 3N hydrochloric acid and further washed five times with ultrapure water and then dried to obtain 9.8 g of a white solid.

The obtained white solid was analyzed by an infrared spectroscopic analysis, whereby it was confirmed that a peak attributable to a SO₂F group in the polymer 1 in the vicinity of 1467 cm⁻¹ disappeared, and a peak attributable to a SO₂NH₂ group in the vicinity of −1388 cm⁻¹ was formed (hereinafter referred to as “the polymer 2”).

Step (B):

Then, 1 g of the polymer 2 and 20 g of N,N-dimethylacetamide (DMAc) dehydrated by using molecular sieves 4A, were put in a flask equipped with a cooling condenser and dissolved, and then, under sealing with nitrogen, 1.02 g of N,N′-tetramethylethylenediamine (TMEDA) and then 2.34 g of FSO₂(CF₂)₂SO₂F (BSTFE) were charged, followed by heating and stirring under a condition of 80° C. for 48 hours. The molar ratio of BSTFE to the —SO₂NH₂ group in the polymer 2 was 8:1.

The obtained solution was a uniform solution, and no gelation was observed.

To the solution before the reaction (the solution having the polymer 2 dissolved in DMAc) and to the obtained reaction solution, a very small amount of hexafluorobenzene was added as a standard liquid (−162.5 ppm), and ¹⁹F-NMR was measured, whereby it was confirmed that in the solution before the reaction, a peak attributable to CF₂—SO₂NH₂ observed in the vicinity of −116.2 ppm disappeared, and formation of peaks attributable to —CF₂—SO₂N⁻M⁺SO₂CF₂—CF₂—SO₂F was observed in the vicinity of −104.0 ppm, −115.3 ppm and −110.6 ppm. This reaction solution was cast on a glass petri dish and dried at 80° C. overnight, then vacuum dried at 80° C. for two hours and finally dried at 180° C. for 30 minutes, to obtain a membrane having a thickness of about 250 μm.

Step (C):

Then, the obtained membrane was immersed in a methanolic KOH aqueous solution (KOH concentration: 15 mass %) at 80° C. overnight, then washed with water until the pH of washing water became 7, further washed four times with 3N hydrochloric acid, immersed in a 10 mass % hydrogen peroxide aqueous solution (at 80° C.) overnight, and again washed with 3N hydrochloric acid to remove potassium remaining in the membrane. Thereafter, the membrane was washed with water until the pH of washing water became 7.

The obtained membrane was subjected to IR analysis, whereby the membrane was found to be a membrane made of a polymer wherein the —SO₂F group in the polymer 1 disappeared and was converted to a —SO₂NHSO₂(CF₂)₂SO₃H group.

### Examples 2 and 3

The steps (A) and (B) were carried out in the same manner as in Example 1 except that the molar ratio of BSTFE to the —SO₂NH₂ group in the polymer 2 was changed to 4:1 (Example 2) or 2:1 (Example 3). The obtained reaction solution was a uniform solution, and no gelation was observed. Further, the step (C) was carried out in the same manner as in Example 1 to obtain a membrane.

The obtained membrane was subjected to IR analysis, whereby in each Example, the membrane was a membrane made of a polymer wherein the —SO₂F group in the polymer 1 was converted to a —SO₂NHSO₂(CF₂)₂SO₃H group.

### Example 4

A membrane was obtained by carrying out the steps (A) to (C) in the same manner as in Example 1 except that instead of 2.34 g of BSTFE, 3.22 g of FSO₂(CF₂)₄SO₂F (BSOFB) was used. In the step (B), the molar ratio of BSOFB to the —SO₂NH₂ group in the polymer 2 was 8:1.

The obtained membrane was subjected to IR analysis, whereby the membrane was found to be a membrane made of a polymer wherein the —SO₂F group in the polymer 1 was converted to a —SO₂NHSO₂(CF₂)₄SO₃H group.

### Example 5

The step (A) and up to heating and stirring in the step (B) were carried out in the same manner as in Example 1 except that instead of BSTFE, BSOFB was used, and the molar ratio of BSOFB to the —SO₂NH₂ group in the polymer 2 was changed to 2:1. In the obtained reaction solution, certain gelation was observed, and the viscosity was higher than the solution after the step (B) in Example 3. Thereafter, the obtained solution was put into water, and agglomerated solid was collected and attempted to be dissolved again in DMAc at a concentration of about 5 mass %, whereby an insoluble component was observed, so that the subsequent steps were not carried out.

### [Measurement of Water Uptake]

A membrane was dried at 80° C. for at least two hours, immersed in a warm water of 80° C. for 16 hours and then, cooled until water became at most 25° C., whereupon the membrane was taken out, water attached on the membrane surface was wiped off with filter paper, and the mass of the membrane was measured (mass W1). Then, this membrane was dried at 80° C. for 5 hours, and further dried in a desiccator in a nitrogen atmosphere overnight, whereupon the mass was measured in the desiccator as it was (mass W2), and (W1-W2)/W2 was taken as the water uptake (%).

The type and ratio of the modifying agent (such as the compound (3)) used in the step (B), and the results of measuring the water uptakes in the membranes obtained in Examples 1 to 4, are shown in Table 1. Here, the abbreviations in Table 1 are as follows.

BSTFE: FSO₂(CF₂)₂SO₂F

BSOFB: FSO₂(CF₂)₄SO₂F

TABLE 1

| | | Modifying agent: | |
|---|---|---|---|
| | Modifying | —SO₂NH₂ | Water uptake |
| | agent | (molar ratio) | (%) |
| Ex. 1 | BSTFE | 8:1 | 170 |
| Ex. 2 | BSTFE | 4:1 | 170 |
| Ex. 3 | BSTFE | 2:1 | 170 |
| Ex. 4 | BSOFB | 8:1 | 295 |
| Ex. 5 | BSOFB | 2:1 | — |

As shown in Table 1, the membranes in Examples 1 to 3 obtained by using BSTFE had a low water uptake as compared with the membrane in Example 4 obtained by using BSOFB. It is considered that with the membranes in Examples 1 to 3, the radius of motion of the side chain (the pendant group) in the polymer can be controlled to be small.

### Example 6

A membrane made of a polymer wherein the —SO₂F group in the polymer was converted to a —SO₂NHSO₂(CF₂)₂SO₃H group, was obtained in the same manner as in Example 1 except that a polymer containing 1.0 mmol/g of the —SO₂F group, obtained by polymerizing TFE with a monomer of the following formula (m2), was reacted with fluorine gas and fluorinated to obtain a stabilized polymer (hereinafter referred to as “the polymer 3”), which was used in the step (A) instead of the polymer 1, and a polymer thereby obtained (hereinafter referred to as “the polymer 4”) was used in the step (B) instead of the polymer 2, and the molar ratio to the —SO₂NH₂ group in the polymer 4 was changed to 4:1.

CF₂═CF—OCF₂CF(CF₃)O(CF₂)₂SO₂F (m2)

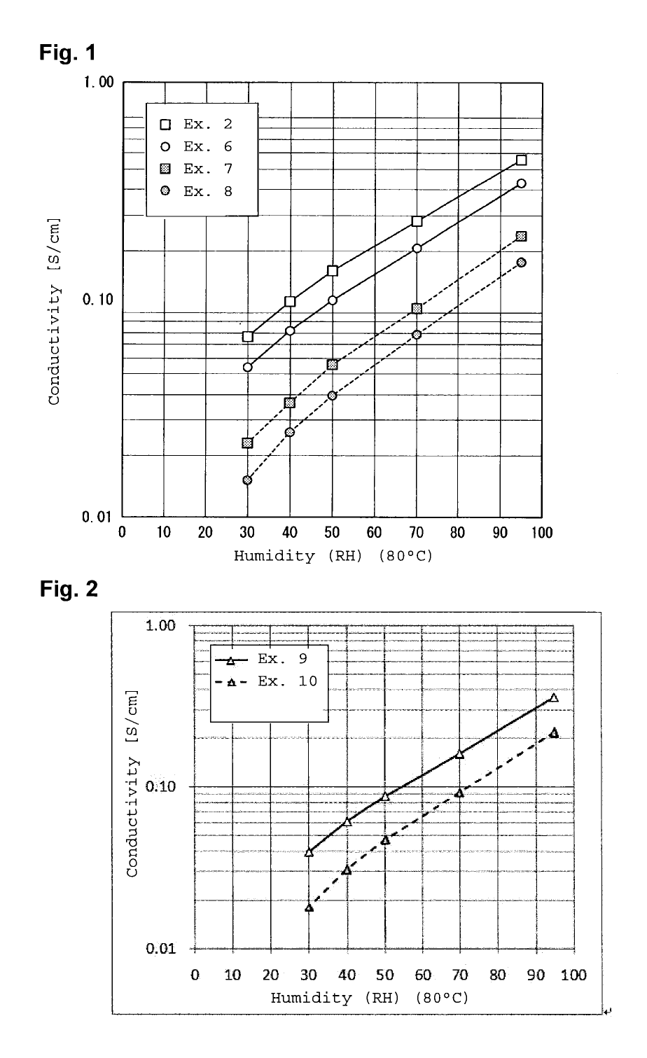

The conductivity of the obtained membrane at 80° C. was measured, and the result is shown in FIG. 1.

### Example 7

The polymer 1 was extrusion-molded at a molding temperature of 240° C. to obtain a film having a thickness of 50 μm (hereinafter referred to as “the film 1”). The obtained film 1 was immersed in a solution (80° C.) of dimethylsulfoxide/potassium hydroxide/water=30/15/65 (mass ratio) overnight, then washed with water, then washed four times with 3N hydrochloric acid, immersed in a 10 mass % hydrogen peroxide aqueous solution (80° C.), again washed with 3N hydrochloric acid to remove a potassium content remaining in the film, and finally washed with ultrapure water until the pH of the washing liquid became 7, and dried to obtain a film made of an ionic polymer (terminal group: a —SO₃H group).

The conductivity of the obtained film at 80° C. was measured, and the result is shown in FIG. 1.

### Example 8

A film made of an ionic polymer (terminal group: a —SO₃H group) was obtained in the same manner as in Example 7 except that instead of the polymer 1, the polymer 3 was used.

The conductivity of the obtained film at 80° C. was measured, and the result is shown in FIG. 1.

### [Resistance Measurement]

The conductivity of a polymer was obtained by the following method.

A substrate having four terminal electrodes placed at intervals of 5 mm, was contacted closely to a film or membrane made of the polymer and having a width of 5 mm, and by a known four terminal method, the resistance of the film or membrane was measured at an AC voltage of 1 V at 10 kHz under constant temperature and constant humidity conditions of a temperature of 80° C. and a relative humidity of from 30 to 95%, and the conductivity was calculated from the measured results.

As shown in FIG. 1, the membranes in Examples 2 and 6 obtained by using BSTFE had high ion exchange capacities as compared with the films in Examples 7 and 8 having no pendant group.

### Example 9

A membrane made of a polymer wherein the —SO₂F group of a polymer was converted to a —SO₂NHSO₂(CF₂)₂SO₃H group, was obtained in the same manner as in Example 1 except that a polymer containing 1.1 mmol/g of a —SO₂F group, obtained by polymerizing TFE with a monomer of the following formula (m3), was reacted with fluorine gas and fluorinated to obtain a stabilized polymer (hereinafter referred to as “the polymer 5”), which was used in the step (A) instead of the polymer 1, and a polymer thereby obtained (hereinafter referred to as “the polymer 6”) was used in the step (B) instead of the polymer 2, and the molar ratio to the —SO₂NH₂ group in the polymer 6 was changed to 4:1.

CF₂═CF—CF₂O(CF₂)₂SO₂F (m3)

The water uptake of the obtained membrane was measured, whereby the water uptake was 130%. Further, the conductivity of the obtained membrane was measured, and the result is shown in FIG. 2.

### Example 10

A film made of an ionic polymer (terminal group: a —SO₃H group) was obtained in the same manner as in Example 7 except that instead of the polymer 1, the polymer 5 was used.

The conductivity of the obtained film at 80° C. was measured, and the result is shown in FIG. 2.

The entire disclosure of Japanese Patent Application No. 2011-188305 filed on Aug. 31, 2011 including specification, claims, drawings and summary is incorporated herein by reference in its entirety.

What is claimed is:

1. A process for producing an ionic polymer, which comprises the following steps (A) to (C):
(A) a step of converting a group represented by the following formula (1), in a polymer having repeating units having the group represented by the formula (1), to a group represented by the following formula (2),
(B) a step of reacting the polymer obtained in the step (A) with a compound represented by the following formula (3) to convert the group represented by the formula (2) in the polymer to a group represented by the following formula (4), and
(C) a step of converting the group represented by the formula (4) in the polymer obtained in the step (B) to a group represented by the following formula (5),
—SO₂F (1)
—SO₂NZ¹Z² (2)
FSO₂(CF₂)₂SO₂F (3)
—SO₂N⁻(M⁺)SO₂(CF₂)₂SO₂F (4)
—SO₂N⁻(M⁺)SO₂(CF₂)₂SO₂X⁻(M⁺)(SO₂R^{f})ₘ (5)
wherein each of Z¹ and Z² which are independent of each other, is a group selected from the group consisting of a hydrogen atom, a monovalent metal element and —Si(R)₃, R is a hydrogen atom or a C₁₋₁₂ monovalent organic group which may have an etheric oxygen atom, three R may be the same groups or different groups, M⁺ is a hydrogen ion, a monovalent metal cation or a monovalent cation derived from an organic amine, X is an oxygen atom or a nitrogen atom, m is 0 when X is an oxygen atom, or 1 when X is a nitrogen atom, and R^{f} is a C₁₋₁₀ perfluoroalkyl group which may have at least one etheric oxygen atom.

2. The process for producing an ionic polymer according to claim 1, wherein in the step (B), the molar ratio of the compound represented by the formula (3) to the group represented by the formula (2) is from 0.5 to 20.

3. The process for producing an ionic polymer according to claim 1, wherein the polymer having the group represented by the formula (1) is a perfluoropolymer, wherein hydrogen atoms bonded to carbon atoms in the main chain and side chains are all substituted by fluorine atoms.

4. An ionic polymer having repeating units having a group represented by the following formula (5):
—SO₂N⁻(M⁺)SO₂(CF₂)₂SO₂X⁻(M⁺)(SO₂R^{f})ₘ (5)
wherein M⁺ is a hydrogen ion, a monovalent metal cation or a monovalent cation derived from an organic amine, X is an oxygen atom or a nitrogen atom, m is 0 when X is an oxygen atom, or 1 when X is a nitrogen atom, and R^{f} is a C₁₋₁₀ perfluoroalkyl group which may have at least one etheric oxygen atom.
